(19) United States
(12) Patent Application Publication
(10) Pub. No.: US 2021/0276213 A1
(43) Pub. Date: Sep. 9, 2021

(54) IDENTIFYING PRINT MEDIA BORDERS

(71) Applicant: Hewlett-Packard Development Company, L.P., Spring, TX (US)

(72) Inventors: Francisco Javier Roses Conesa, Sant Cugat del Valles (ES); Jorge Solanas Lerida, San Diego, CA (US)

(73) Assignee: Hewlett-Packard Development Company, L.P., Spring, TX (US)

(21) Appl. No.: 16/326,654

(22) PCT Filed: Oct. 20, 2016
(86) PCT No.: PCT/US2016/057927

§ 371 Date: Feb. 19, 2019

(51) Int. Cl. B26D 1/18; B41J 11/70; B41J 11/00; B26D 1/06

(52) U.S. Cl. CPC B26D 1/18; B41J 11/706; B26D 1/065; B41J 11/0065; B41J 11/003

(57) ABSTRACT

Devices and methods for identifying border positions of print media in image forming apparatuses are disclosed. In an example method print media are advanced in a feeding direction to reach a cutting position, a cutter is advanced in a cutting direction, perpendicular to the feeding direction to cut the print media, changes in friction are identified when the cutter contacts the print media, positions of the cutter are identified when the changes in friction are identified and border positions are determined based on the identifying of cutter positions.

### BACKGROUND

Image forming apparatuses form images on media. Image forming apparatuses may be supplied with a variety of media including media in a form of a media supply roll. The roll media may be transported along a media transport path to a print zone to be printed thereon. The roll media may be cut by a cutter and output to a storage bin.

### BRIEF DESCRIPTION

Some non-limiting examples of the present disclosure are described in the following with reference to the appended drawings, in which:

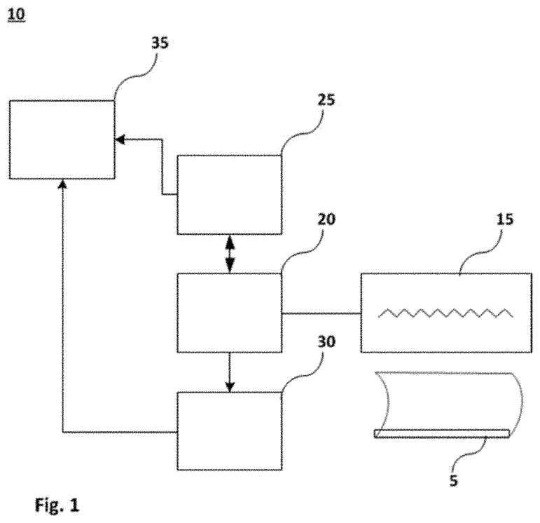

FIG. 1 schematically illustrates a device for identifying print media borders according to an example.

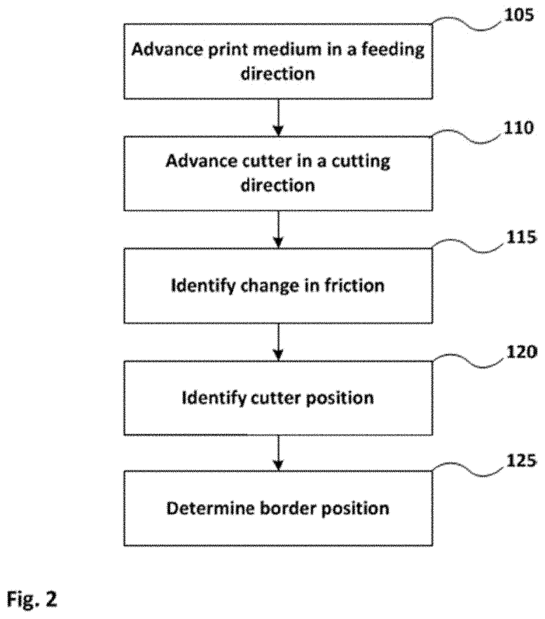

FIG. 2 is a flow chart of an example method of identifying a border position of a print medium.

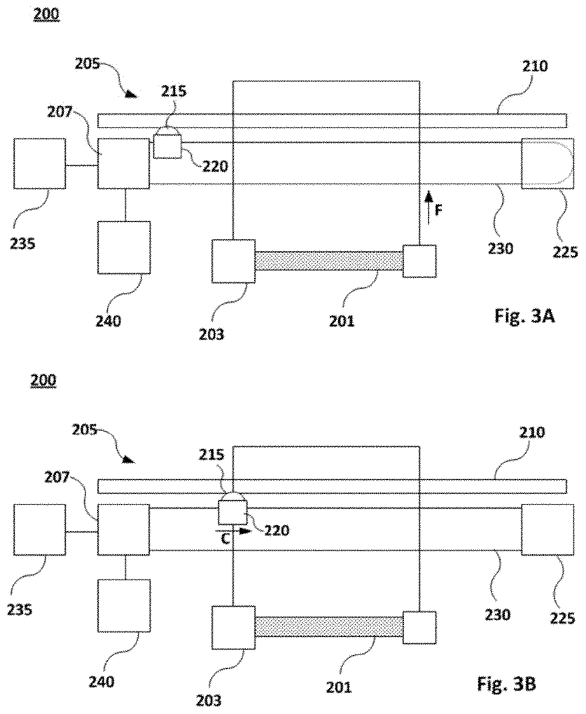

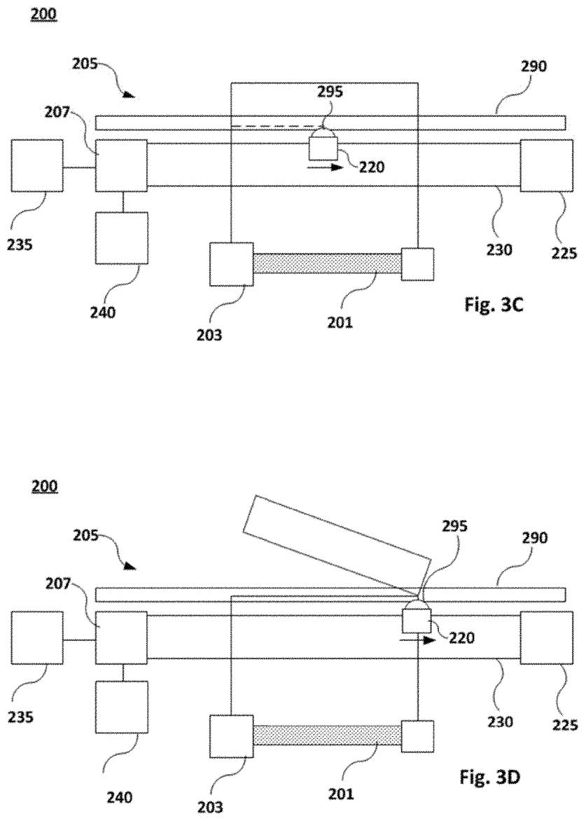

FIG. 3A to FIG. 3D schematically illustrate a device to perform print medium border identification according to an example.

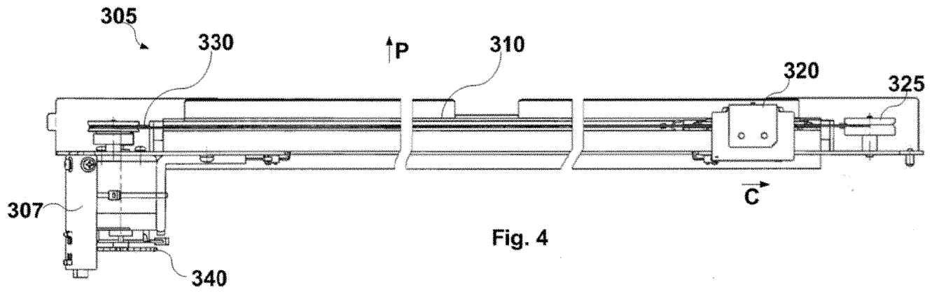

FIG. 4 is a line diagram schematically illustrating a cutter according to an example.

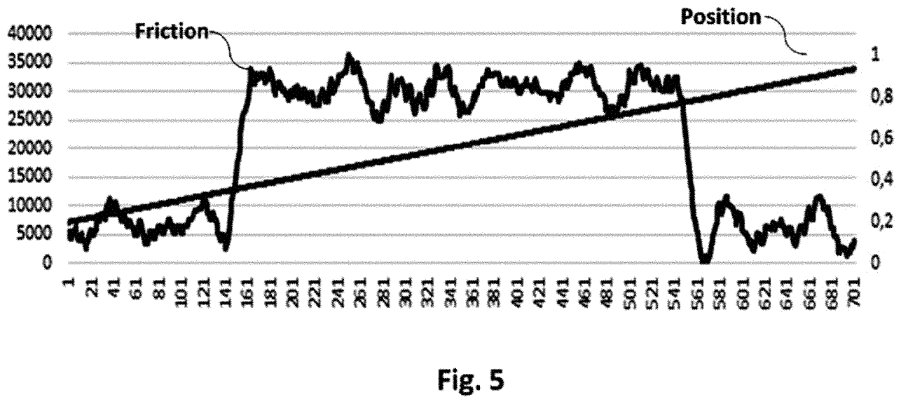

FIG. 5 is a chart schematically illustrating friction levels associated with disc cutter position over time according to an example.

### DETAILED DESCRIPTION

An image forming apparatus, e.g. a printer, using a print substrate in the form of a media supply roll, also known as continuous roll or endless roll, may use cutters before and after printing. Before printing a cleaning cut may be performed using a cutter to clear any irregular shape or impurity on the leading edge of the print substrate.

Knowing the width and position of the print substrate in the print zone may allow precision printing on the print substrate or printing using reduced or no margins and may avoid any printing, i.e. recreating a digital image by propelling droplets of print fluid onto the print substrate, outside the print substrate that may cause smearing or damage to hardware.

Some printers use mechanical means to align (e.g. center) the print substrate in the printer. Thus, knowing a position of a single border of the print medium allows the calculation of the width and the determination of the position of the print medium in the print zone. Some printers automatically center the print substrate. If the print medium is automatically centered in the print zone, knowing the position of any one of the two borders may be sufficient to calculate the width. Other printers align the print substrate at an edge of the print zone. If the alignment is at an edge, then one border's position may be considered known, i.e. the border at the alignment edge. Thus, the position of the border further from the alignment edge may be determined to calculate the width of the print substrate.

Some printers allow a print medium with a predetermined width to be inserted. Thus, the print medium width may be considered known. However, even if the width is known, the exact position of the print medium may not be known, e.g. if the printer has no alignment process. In such cases, at least one border position may be measured to determine the position of the print substrate in the printer.

Some printers vary, either randomly or deterministically, the position of the print substrate in the print zone for each job to avoid repetitive use of the same printing heads at the borders. Furthermore, they may allow various or any print substrate width to be used, provided that the print substrate fits in the print zone. Thus, in such cases, both border positions may be identified to measure width and determine position of the print medium.

In an image forming apparatus that uses a cutter, identifying a border's position may be performed by measuring changes in friction when the cutter comes in contact with the print medium and by identifying the cutter's position at the moment of friction change. Identifying a border's position may be performed by using an encoder attached to the actuator, e.g. motor, of the cutter. The encoder may register the position of the cutter with a precision that allows unequivocal determination, e.g. with millimetre precision. When friction changes (which may be an indication of a border), the motor's speed may be momentarily altered; it may decrease when the cutter starts to cut because of friction between the cutter and the print medium, and may increase when the cutter completes the cutting because of the absence or sudden reduction of friction between the cutter and the print medium. In some cases the cutter may be in contact with a guide when no print medium is present. Thus a friction level may always be registered when the cutter is moving. By measuring a friction change, any friction level present in the absence of a print medium may not influence the friction change measurement results. Some actuators, e.g. DC motors or servo motors, may be driven by controllers using pulse-width-modulation (PWM) signals. In such cases the friction change may be registered as a change in the width of the pulse of the PWM signal or as a change in the voltage level used to power the motor. The change, i.e. the moment a change is identified, may be associated with the encoder's registered position of the cutter at the same moment in time. Thus, it is possible to identify the border or borders of the paper and determine size and position accordingly. If one border or the center of the print medium is already identified, e.g. if the print medium is automatically aligned by the printer, then with one border position identification it may be possible to calculate width and position of the print medium in the print zone. Otherwise, both borders may be identified.

FIG. 1 schematically illustrates a device for identifying print medium borders according to an example. The print medium may be provided in a print zone. The device 10 may comprise a cutter 15 and an actuator 20 for the cutter. The cutter may cut a print medium 5 along a cutting dimension. The actuator 20 may advance the cutter 15 along the cutting dimension. Furthermore, the device 10 may comprise an encoder 30, coupled to the actuator. The device may further comprise a controller 25, connected to the actuator, to control the actuator 20, to register the position of the cutter 15 along the cutting dimension and to measure friction changes as a result of the cutter 15 finding resistance from the print medium when cutting is performed. The device may also comprise a processor 35 to receive the measured friction changes and the position of the cutter 35 from the controller 25. Based on the received data, the processor may identify a border position for the print medium 5. Based on the identified border position it may then identify the width of the print medium 5. More specifically, if the print medium was aligned or centered to enter the print zone, then, as an alignment or centering point may be known, with one border position the processor 35 may calculate the width of the print medium 5. If the print medium was not aligned or centered in the print zone, then the device may identify a second border position so that the processor 35 may calculate the width of the print medium as the absolute difference between the two positions.

FIG. 2 is a flow chart of a method of identifying a border position of a print medium in a printer. The print medium may be in the form of a media supply roll or an endless roll. In block 105 the print medium may be advanced in a feeding direction to reach a cutting position. The feeding direction may be the direction that the print medium advances to reach a print zone. The cutting position may be a position before the print medium enters the print zone where a part of the print medium is to be removed (i.e. cut) by a cutter. In block 110 the cutter may be advanced in a cutting direction to cut the print medium. The cutting direction may be perpendicular to the feeding direction. In block 115 a change in friction may be identified when the cutter contacts the print medium. As the cutter advances in the cutting direction it may find resistance from the print medium. At the moment the cutter contacts the print medium, i.e. at the border of the print medium, the cutter may experience a momentary drop at its speed due to the change in friction. In block 120 the position of the cutter may be identified when the change in friction is identified. The cutter position may be identified by registering the position using an encoder and by associating the registered position with a position in the print zone. Thus, in block 125 the position of the print medium's border in the print zone may be determined based on the identifying of the position of the cutter. It is noted that before advancing the cutter an initialization may take place. During the initialization the cutter, or a cutter disc of the cutter, may be positioned at a reference position so that the encoder may thereafter correctly and consistently register the position of the cutter or cutter disc along the cutting direction. The initialisation may be performed when the imaging device is powered on or before a printing or cutting operation.

FIG. 3A to FIG. 3D schematically illustrate a device to perform print medium border identification according to an example. Image transfer device 200 may comprise a feeder 203 to feed print medium 201 into a print zone. The device 200 may further comprise a cutter 205. The cutter may be placed before the print zone. The print medium 201 may be in the form of an endless roll. The feeder 203 may engage with the endless roll 201 and advance the print medium in a feeding direction F and through cutter 205. The cutter 205 may comprise a guide 210, a cutting disc 215, a disc housing 220, a pulley 225 and a motor 207. The guide 210 may be in the form of a horizontal bar. The cutting disc 215 may be rolling along the guide. The disc housing 220 may partially house the cutting disc 215. The pulley 225 may be coupled to the motor 207. A cable 230 may be coupled to the disc housing 220 and to the pulley 225. When the motor 207 is powered, the pulley 225 may rotate and, with it, the cable 230 that carries the disc housing 220 and the cutting disc 215 may move along a cutting direction C, perpendicular to the feeding direction. The device may further comprise a controller 235 to control the motor 207. The motor 207 may be a servomotor and the controller 235 may be a proportional-integral-derivative (PID) controller using pulse-width modulation. Furthermore, the device 200 may comprise an encoder 240. The encoder 240 may be coupled to the motor 207. The encoder 240 may register motor position or rotation associated with the position of the cutting disc 215 along the cutting direction. More specifically:

In FIG. 3A the cutting disc 215 is illustrated in a resting position. The feeder 203 may rotate the endless roll 201 so that print medium may be inserted in the print zone. The print medium may be guided by guide 210. The feeder 203 may provide a predetermined quantity or length of print medium to the print zone. Then the feeder 203 may stop. The feeder stopping may trigger the controller 235 of the motor 207. In FIG. 3B the cutter 205 may be activated. The motor 207 may be powered by controller 235 and the cable 230 may start moving and, alongside, disc housing 220 and cutting disc 215. As the cutting disc advances it may initially roll along the guide 210 in an area of the guide where no print medium may be present. This rolling may generate a first friction level that may be sampled by controller 235. At the same time, the controller may sample the encoder 240 signals that correspond to the position of the cutting disc. The encoder 240 may have associated the rotational angle of the motor 207 with the position of the cutting disc 215. For example, if the motor makes ten rotations to advance the cutting disc from one side of the guide to the other side, then, for each degree of the motor's rotation the cutting disc, the cutting disc will have travelled one 2/(360*10) distance along the guide. For example, for a cutting distance of one meter (1 m), this may allow the determination of the cutters position with sub-millimetre precision.

FIG. 2B illustrates the moment the cutting disc 215 makes contact with the print medium. Up until the moment of contact the friction between the cutting disc 215 and the guide 210 may be stable and the cutting disc 215 may have reached a relatively constant speed, e.g. a predetermined speed. However, at the moment in time when the cutting disc 215 contacts the print medium a sudden drop in the cutting disc's speed may be sensed by the controller 235. Then the controller 235 may increase the power (width of pulse PWM signal or amplitude of voltage) of the motor to maintain the speed. This moment may be identified as the moment the cutting disc 215 touches the border of the print medium 201. Then this moment may be associated with the position of the cutting disc as registered using the encoder 240. Knowing the moment of contact by the controller 235 and the position of the cutting disc by the encoder 240 allows determining the position of the border of the print medium along the cutting direction in the print zone.

FIG. 3C shows the cutting disc cutting through the print medium. During the time it takes to traverse the print medium, the cutting disc 215 may have assumed again a constant speed, as the controller 235 may have increased the width of the PWM pulse or raised the voltage to counter the resistance of the print medium and the increased friction. Therefore, during the time it takes to cut through the print medium, no changes in the cutter's speed may be recorded. FIG. 3D shows the cutting disc 215 at the moment it finishes cutting and “exits” from the print medium. At that moment, a reverse situation may be sensed by the controller. As the friction may suddenly drop, due to absence of print medium, the velocity of the cutter disc may momentarily increase. The controller may perceive this increase in velocity and reduce the voltage or duration of the PWM pulse to return the cutter to the predetermined speed. This moment in time may be identified as the moment the cutting disc 215 leaves from the border of the print medium. Thus, again, this moment may be associated with the position of the cutting disc 215 as registered by the encoder 240. It may correspond to the position of the second border of the print medium. Now, knowing the positions of the two borders along the cutting direction may allow calculating the width of the print medium (i.e. as the distance between the two identified border positions).

The controller 235 may comprise a processor 237 coupled to a memory 239. The memory 239 stores motor control instructions that, when executed by the processor 239, control the motor to maintain a predetermined speed of the cutter. The controller 235 may be a motor controller, i.e. provided to control the motor of the cutter, or it may be part of a controller of the image transfer device, e.g. part of a printer's controller that may control various aspects of the printing process (e.g. print medium feeding, print medium cutting, delivery of print fluid to the print medium, etc.). Furthermore, in some implementations, the calculations with respect to the print medium width and position may be performed by the cutter controller based on data generated therewith and received by the encoder. Then the cutter controller may communicate the results to the image transfer device's, e.g., printer's, controller. In other implementations, the calculations and/or the determination of the print medium width and position may be performed by the printer controller based on data received by the cutter controller and/or by the encoder.

FIG. 4 is a line diagram schematically illustrating a cutter according to an example. Cutter 305 may comprise a guide 310, a disc housing 320 to house a cutting disc (not shown), a pulley 325 and a motor 307. The guide 310 may be in the form of a horizontal bar. The cutting disc may be rolling along the guide. The disc housing 320 may partially house the cutting disc 215. The pulley 325 may be coupled to the motor 307. A cable 330 may be coupled to the disc housing 320 and to the pulley 325. When the motor 307 is powered, the pulley 225 may rotate and, with it, the cable 330 that carries the disc housing 320 (with the cutting disc) may move along a cutting direction C, perpendicular to a feeding direction P. Furthermore, the cutter 305 may comprise a rotary encoder 340. The rotary encoder 340 may be coupled to the motor 307. The encoder 340 may register motor rotation associated with the position of the cutting disc along the cutting direction. For example, the rotary encoder may comprise an optical sensor and markings, wherein the optical sensor may register a plurality of cutter positions for each rotation of the motor. Each marking may correspond to a cutter position along the cutting direction for each motor revolution. The cutter 305 may be used in an image forming apparatus (e.g. printer) that employs roll media.

FIG. 5 is a chart schematically illustrating friction levels associated with disc cutter position over time according to an example. The horizontal axis represents number of iterations. The left vertical axis represents cutter position in the encoder unit, with a resolution of 32 units per millimetre. The right vertical axis represents levels of friction. As may be observed in FIG. 5, there is a lower level of friction (oscillating around approximately 0.2 friction units) up to around sample 141. Then, suddenly, friction increases and begins oscillating around approximately 0.8 friction units. This may be attributed to the presence of a print medium. In the example of FIG. 5 the print medium is glossy paper having a width of 480 mm. At the first print medium border where the jump in friction level takes place, an encoder registered position may be identified. Accordingly, at the second print medium border where a drop in friction level takes place, another encoder registered position may be identified. In the example of FIG. 5 friction increases at encoder position 12928 and decreases at position 28282. The printer controller may have a table associating encoder positions with positions along the cutting direction. Thus by knowing the encoder positions, the printer controller may calculate and determine the border positions and the width of the print medium. More specifically, in the example of FIG. 5, the length of the print zone in the cutting direction may be 1000 mm and there may be 32000 encoder positions. Thus to measure the width of the paper the following calculation may be performed:

$$Paper width = \vert EP 2 - EP 1 \vert \times \frac{PL}{{EP}_{total}}$$

Where EP1 and EP2 are the encoder positions where a change was identified, PL is the print zone length and EPₜₒₜₐₗ is the total number of encoder positions. Thus for the example of FIG. 5,

$$Paper width = \vert 28282 - 12928 \vert \times \frac{1000}{32000} = 479.8125 mm$$

It will be appreciated that examples described herein may be realized in the form of hardware or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disc or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine readable storage storing such a program. Still further, some examples may be conveyed electronically via any medium such as a communication signal carried over a wired or wireless connection.

All of the features disclosed in this specification (including any accompanying claims, abstract and drawings), and/or all of the operations of any method or process so disclosed, may be combined in any combination, except combinations where at least some of such features and/or operations are mutually exclusive.

Each feature disclosed in this specification (including any accompanying claims, abstract and drawings), may be replaced by alternative features serving the same, equivalent or similar purpose, unless expressly stated otherwise.

Although a number of particular implementations and examples have been disclosed herein, further variants and modifications of the disclosed devices and methods are possible. As such, representative examples of the present disclosure have utility over a wide range of applications, and the above discussion is not intended and should not be construed to be limiting, but is offered as an illustrative discussion of aspects of the disclosure. Many variations are possible within the spirit and scope of the disclosure, which is intended to be defined by the following claims—and their equivalents—in which all terms are meant in their broadest reasonable sense unless otherwise indicated.

1. A method of identifying a border position of a print medium, the method comprising:
advancing the print medium in a feeding direction to reach a cutting position;
advancing a cutter in a cutting direction, perpendicular to the feeding direction to cut the print medium;
identifying a change in friction when the cutter contacts the print medium;
identifying the position of the cutter when the change in friction is identified;
determining the border position based on the identifying of the position of the cutter.

2. The method according to claim 1, wherein identifying a change in friction comprises identifying a change in a speed of the cutter.

3. The method according to claim 2, wherein the cutter is driven by a motor and wherein identifying a change in the cutter's speed comprises identifying a change in rotational speed of the motor driving the cutter.

4. The method according to claim 3, wherein the motor is driven by a pulse-width-modulation signal and wherein identifying a change in the rotational speed of the motor driving the cutter comprises identifying a change in the width of the pulse of the signal.

5. The method according to claim 4, wherein the motor is a DC motor and wherein identifying a change in the speed of the motor driving the cutter comprises identifying a change in the amplitude of the voltage powering the DC motor.

6. The method according to claim 3, wherein identifying the position of the cutter comprises identifying a register record of an encoder coupled to the motor.

7. The method according to claim 6, comprising registering cutter positions associated with motor rotations, respectively.

8. The method according to claim 1, comprising calculating a width of the print medium based on the determined border position and a predetermined alignment position.

9. The method according to claim 1, comprising determining two border positions and calculating a width of the print medium based on the determined two border positions.

10. A device to determine a print medium's width along a cutting dimension, comprising:
a cutter, to cut the print medium along the cutting dimension;
an actuator, to advance the cutter along the cutting dimension;
an encoder, coupled to the actuator;
a controller, connected to the actuator, to register the position of the cutter along the cutting dimension and to measure friction changes as a result of the cutter finding resistance from the print medium when cutting; and
a processor to
receive measured friction changes;
identify respective cutter positions;
identify border positions of the print medium based on the identified respective cutter positions;
determine width of print medium based on the identified border positions.

11. The device according to claim 10, wherein the actuator comprises a motor.

12. The device according to claim 11, wherein the cutter comprises:
a guide;
a cutting disc, rolling along the guide;
a disc housing, to partially house the cutting disc;
a pulley, coupled to the motor,
a cable, coupled to the disc housing and to the pulley,
wherein the motor is to rotate the pulley.

13. The device according to claim 11, wherein the motor comprises an axis of rotation and the encoder comprises a rotary encoder.

14. The device according to claim 13, wherein the encoder comprises an optical sensor and markings, wherein the optical sensor is to register a plurality of cutter positions for each rotation of the motor, each marking corresponding to a cutter position along the cutting direction.

15. An image forming apparatus, comprising:
a feeder, to advance a print medium in a feeding direction;
a cutter, to cut the print medium in a cutting direction, perpendicular to the feeding direction;
a motor, connected to the cutter, to advance the cutter in the cutting direction;
an encoder, connected to the motor, to register positions of the cutter along the cutting direction in time
a controller, coupled to the encoder, to:
detect changes in the motor's speed as the cutter advances in the cutting direction to cut the print medium; and
identify the registered position at the encoder during the motor speed changes,
wherein the printer is to identify a border of the print medium along the cutting direction based on the detected changes in the motor speed and the registered position of the cutter when a change in the motor's speed is detected.
